(19) United States
(12) Patent Application Publication
(10) Pub. No.: US 2010/0054655 A1
(43) Pub. Date: Mar. 4, 2010

(54) Dynamic Reconfigurable Optical Interconnect System

(75) Inventors: Alexei L. Glebov, San Mateo, CA (US); Michael G. Lee, Santa Jose, CA (US)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 12/200,222

(22) Filed: Aug. 28, 2008

(51) Int. Cl. G02B 6/12; G02F 1/295

(52) U.S. Cl. 385/9; 385/14

(57) ABSTRACT

An optical interconnect system includes an integrated circuit, at least one optical modulator, and a slab waveguide. The optical modulator is coupled to the integrated circuit and receives an input light beam from a light source and data from a source device and generates a modulated output light beam. The slab waveguide is coupled to the optical modulator and includes at least one input waveguide microlens, a plurality of output waveguide microlenses, and at least one deflector prism. The input waveguide microlens focuses the modulated output light beam from the modulator into a collimated light beam. The deflector prism is coupled to the integrated circuit, receives the collimated light beam from the input waveguide microlens, and deflects the collimated light beam toward one of the output waveguide microlenses according to an input voltage.

### TECHNICAL FIELD

This disclosure relates in general to optics and more particularly to a dynamic reconfigurable optical interconnect system.

### BACKGROUND

Optical interconnects are likely replacements for traditional electrical interconnects between components on circuit boards. Unlike electrical interconnects, optical interconnects provide little or no signal propagation delay. In addition, optical interconnects provide for a significant increase to the available bandwidth of board-level interconnects.

Traditional optical interconnects employ predefined optical paths between data ports on various components. These paths typically consist of fixed optical channel waveguides that are formed on a substrate. These paths are dedicated paths that may only be utilized by the two data ports to which they connect. This results in an inflexible architecture for optical routing and chip-to-chip communication.

### SUMMARY OF THE DISCLOSURE

The present disclosure provides a dynamic reconfigurable optical interconnect system that substantially eliminates or reduces at least some of the disadvantages and problems associated with previous methods and systems.

According to one embodiment, an optical interconnect system includes an integrated circuit, at least one optical modulator, and a slab waveguide. The optical modulator is coupled to the integrated circuit and receives an input light beam from a light source and data from a source device and generates a modulated output light beam. The slab waveguide is coupled to the optical modulator and includes at least one input waveguide microlens, a plurality of output waveguide microlenses, and at least one deflector prism. The input waveguide microlens focuses the modulated output light beam from the modulator into a collimated light beam. The deflector prism is coupled to the integrated circuit, receives the collimated light beam from the input waveguide microlens, and deflects the collimated light beam toward one of the output waveguide microlenses according to an input voltage.

Technical advantages of certain embodiments may include a reduction in wiring density requirements for a circuit board, a decrease in the number of active elements required to interconnect optical ports on a circuit board, a reduction in the cost of the overall system, and/or an increase in overall system performance. Other advantages may include higher flexibility for optical signal routing, a reduction in the crosstalk between optical channels, and an increase in system bandwidth. Embodiments may eliminate certain inefficiencies such as requiring a dedicated optical channel waveguide between every optical data port on a circuit board. Some embodiments may also eliminate the need for additional multiplexing devices in order to provide wavelength multiplexing capabilities.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a simplified block diagram illustrating an optical circuit where a particular embodiment of this disclosure may be utilized;

FIG. 2 illustrates a dynamic reconfigurable optical interconnect system in accordance with a particular embodiment of this disclosure;

FIG. 3 illustrates a dynamic reconfigurable optical interconnect system in accordance with another particular embodiment of this disclosure; and

FIG. 4 illustrates a multiplexing dynamic reconfigurable optical interconnect system in accordance with yet another particular embodiment of this disclosure.

### DETAILED DESCRIPTION OF THE DISCLOSURE

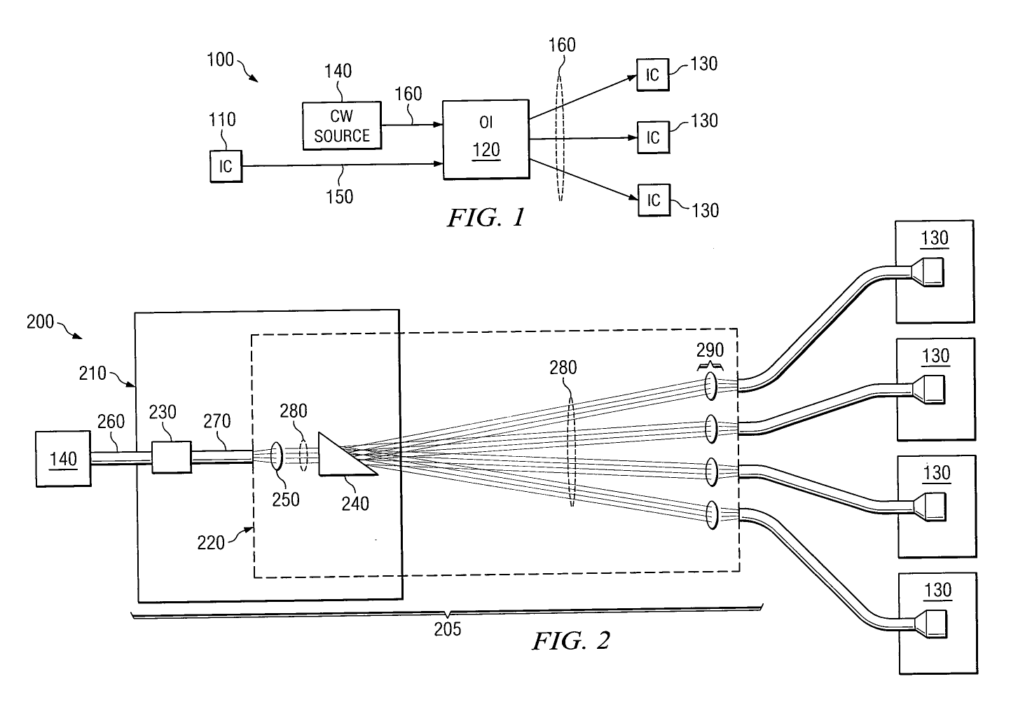

FIG. 1 depicts an optical circuit 100 where a particular embodiment may be utilized. Optical circuit 100 includes a data source 110, an optical interconnect 120, one or more receiving devices 130, and a continuous wave (“CW”) light source 140. Data source 110 is coupled to optical interconnect 120 via an electrical data link 150. CW light source 140 is coupled to optical interconnect 120 via an optical link 160. Optical interconnect 120 is also coupled to receiving devices 130 via optical links 160. Optical links 160 include, but are not limited to, optical waveguides, such as rectangular waveguides, slab waveguides, optical fibers, and the like. Data source 110 and receiving devices 130 may be integrated circuits (“IC”), or any other suitable device that transmits and/or receives data.

In operation, data source 110 outputs data to optical interconnect 120 via electrical data link 150. Optical interconnect 120 receives this data, along with a CW light beam from CW light source 140. Optical interconnect 120 generates a modulated light beam from the input CW light beam that corresponds to the data received from source device 110. This modulated light beam is then transmitted to one or more receiving devices 130 via optical links 160.

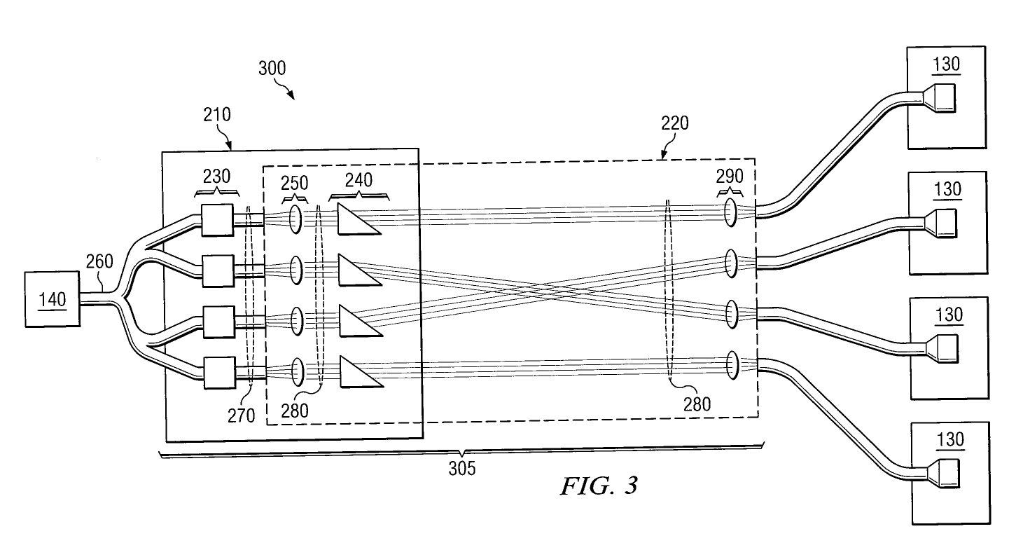

FIG. 2 depicts a dynamic reconfigurable optical interconnect system 200 in accordance with a particular embodiment. Dynamic reconfigurable optical interconnect system 200 includes a CW light source 140, an optical interconnect 205, and one or more receiving devices 130. CW light source 140 is optically coupled to optical interconnect 205, which is in turn optically coupled to the one or more receiving devices 130.

Optical interconnect 205 includes a main IC 210, a modulator 230, an input waveguide microlens 250, a deflector prism 240, a slab waveguide 220, and one or more output waveguide microlenses 290. Optical interconnect 205 could be utilized as optical interconnect 120, discussed above in connection with FIG. 1. Modulator 230 is coupled to CW light source 140 and input waveguide microlens 250. Input waveguide microlens 250, deflector prism 240, and output waveguide microlenses 290 are all located within slab waveguide 220.

Main IC 210 is coupled to modulator 230 and deflector prism 240. Main IC 210 is an example of source device 110 discussed above in connection with FIG. 1. Main IC 210 supplies data to be modulated to modulator 230 and supplies a control voltage to deflector prism 240. In another embodiment, modulator 230 may alternatively be coupled to a modulator driver IC (not shown) that controls the modulation of modulator 230. In such an embodiment, the modulator driver IC may be coupled to Main IC 210, or any other device that supplies data to be modulated.

In operation, CW light source 140 produces a CW light beam 260 and transmits it to modulator 230 in optical interconnect 205. CW light source 140 may be a laser, or any other device that produces a CW light beam. Modulator 230 receives CW light beam 260 and produces a modulated output light beam 270 corresponding to a data input. The data input may be from Main IC 210 or a modulator driver IC as described above. Modulator 230 transmits modulated output light beam 270 to input waveguide microlens 250 in slab waveguide 220. Input waveguide microlens 250 receives modulated output light beam 270 and generates a collimated light beam 280. Input waveguide microlens 250 transmits collimated light beam 280 to deflector prism 240. Deflector prism 240 receives collimated light beam 280 and directs it to an output waveguide microlenses 290 via slab waveguide 220. Each output waveguide microlens 290 is optically coupled to, and transmits the received collimated light beam 280 to, a receiving device 130.

Receiving devices 130 include optical detectors (not shown) which receive optical signals and convert them into electrical signals. In some embodiments, receiving devices 130 may additionally include filters (not shown) for filtering desirable wavelengths of light out of collimated light beam 280. Receiving device 130 may be, for example, an IC that is surface-mounted on a circuit board including the same circuit board as optical interconnect 205. If receiving device 130 is surface-mounted on a circuit board, 45 degree reflection mirrors (not shown) may be used to vertically redirect collimated light beam 280 to the optical detectors in receiving devices 130. Once collimated light beam 280 is converted into electrical signals by an optical detector, receiving device 130 then may process the data that was modulated onto collimated light beam 280.

Modulator 230 may be any optical modulator including, but not limited to, a typical electro-optic modulator. In one embodiment, for example, modulator 230 may be constructed of channel waveguides that are formed with three polymer layers: a lower cladding, an upper cladding, and a core layer in between the upper and lower cladding layer. The core layer may consist of an electro-optic material whose refractive index may be adjusted according to a voltage bias. Such modulators have been previously disclosed and are well known in the art. Modulator 230 may be optically coupled to input waveguide microlens 250 inside slab waveguide 220 in a variety of ways including, but not limited to, optical fibers and waveguides. In some embodiments, modulator 230 may simply be located adjacent to slab waveguide 220 and transmit output light beam 270 to input waveguide microlens 250 through air.

As noted above, modulated output light beam 270 travels from modulator 230, through input waveguide microlens 250 and deflector prism 240, and ultimately to an output waveguide microlens 290 via slab waveguide 220. Slab waveguide 220 may consist of three layers: a lower cladding layer, a core layer, and an upper cladding layer. Light travels through the core layer of slab waveguide 220 which may be constructed of a polymer or any material that allows light to propagate. The core layer and the cladding layers may be formed by various processes including, but not limited to, spin coating and thermal curing. The material of the core layer of slab waveguide 220 also has electro-optic properties that allow its refractive index to change when an electric field is applied. This change in refractive index almost instantaneously affects the light traveling through the core layer and enables deflector prism 240 to deflect collimated light beam 280 in a lateral direction in order to direct it to an output waveguide microlenses 290.

Input waveguide microlens 250 and one or more output waveguide microlenses 290 may be formed inside the core layer of slab waveguide 220 by various techniques. In one embodiment, plasma etching may be used to remove portions of the core layer of slab waveguide 220 in order to form lens-shaped cavities. A dispensing process may then be used to fill in the cavities with lens material fill-in in order to form input waveguide microlens 250 and one or more output waveguide microlenses 290.

To form the deflector prism 240 portion inside slab waveguide 220, two metal electrodes may be placed between the core and cladding layers of slab waveguide 220: one between the lower cladding layer and the core layer, and the other between the core layer and upper cladding layer. One of the electrodes may be in the shape of a prism and/or a triangle and both electrodes may be formed by processes including, but not limited to, sputtering and wet etching through patterned photoresist. Alternatively, the electrodes may be placed on the outside of the cladding layers so the cladding layers rather than the electrodes are adjacent to the core layer. In such an embodiment, the light passing through the core layer has less interaction with the metal electrodes and therefore less optical loss due to metal absorption will occur. Applying a voltage to the electrodes will change the refractive index of the core layer inside deflector prism 240 (the core material between the two electrodes that is made of electro-optic material) and thus cause the deflection of collimated light beam 280 in a lateral direction. Applying different voltages to the electrodes will cause the light to deflect in different directions.

In this manner, different voltages may be applied to deflector prism 240 in order to dynamically redirect collimated light beam 280 to different output waveguide microlenses 290. This provides a substantial improvement over existing optical interconnects. Typically, light beams travel from devices such as modulator 230 to devices such as output waveguide microlens 290 via channel waveguides. Channel waveguides provide only static connections between two optical devices. This embodiment, however, provides a way to dynamically control the destination of collimated light beam 280 by adjusting the voltage input to deflector prism 240. This provides improved flexibility, a decrease in the number of active elements required to interconnect optical ports on a circuit board, and a reduction in the cost of the overall system.

While the embodiment in FIG. 2 has been described in detail, numerous changes, substitutions, variations, alterations, and modifications to dynamic reconfigurable optical interconnect system 200 may be ascertained by those skilled in the art. For example, deflector prism 240 may be formed with various materials such as ferroelectric oxides in a separate process and then hybrid integrated on the substrate with polymer waveguides. In a similar manner, modulator 230 may be fabricated separately and then hybrid integrated on the substrate with polymer waveguides. In other embodiments, deflector prism 240 may be replaced with a micro mirror. Such modifications may require more complicated and costly fabrication processes, but may provide increased performance in some embodiments.

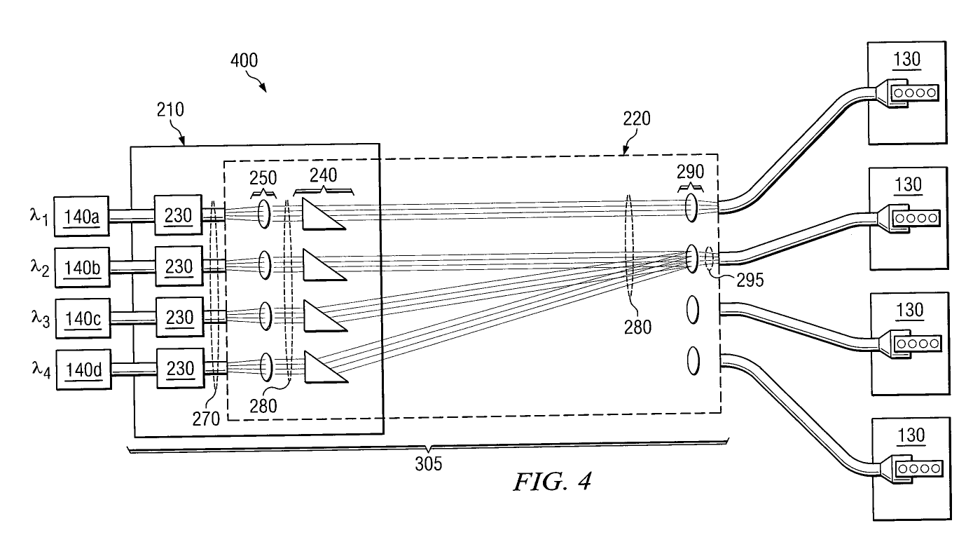

FIG. 3 depicts another embodiment of a dynamic reconfigurable optical interconnect system 300. Dynamic reconfigurable optical interconnect system 300 includes optical interconnect 305 which is similar to optical interconnect 205, but with modifications to increase its flexibility. Optical interconnect 305 includes a main IC 210, one or more modulators 230, one or more input waveguide microlenses 250, one or more deflector prisms 240, a slab waveguide 220, and one or more output waveguide microlenses 290. Main IC 210 is coupled to modulators 230 and deflector prisms 240. Modulators 230 are coupled to CW light source 140 and input waveguide microlenses 250. Input waveguide microlenses 250, deflector prisms 240, and output waveguide microlenses 290 are all located within slab waveguide 220 and may be fabricated as discussed above.

Dynamic reconfigurable optical interconnect system 300 operates similarly to dynamic reconfigurable optical interconnect system 200, described above in reference to FIG. 2. In this embodiment, however, there are two or more modulated output light beams 270, and two or more collimated light beams 280. Like in dynamic reconfigurable optical interconnect system 200, a voltage may be applied to each deflector prism 240 in order to dynamically redirect its collimated light beam 280 to a particular output waveguide microlens 290. This provides for an m-to-n optical interconnect, where m is the number of data inputs and n is the number of data outputs. This is a modification of dynamic reconfigurable optical interconnect system 200, which provides a 1-to-n optical interconnect.

Dynamic reconfigurable optical interconnect system 300 provides significant advantages over typical static optical interconnects. In typical static optical interconnects, each optical connection requires a dedicated optical path including a separate light source and detector. For example, in a system with three ICs on one side of the substrate and three ICs on the other side of the substrate, a total of eighteen dedicated optical paths would be required to connect an input and output port on each device to the other three devices on the other side of the substrate. Each one of these dedicated optical paths would require a separate light source and detector. By utilizing the embodiments in this disclosure, however, the required components to implement the system would be greatly reduced since only one dynamic reconfigurable optical interconnect system 300 would be required for each direction of communications across the substrate. As a result, there is a significant reduction in the cost of the system, a reduction in the complexity of the system, and an overall increase in the design flexibility.

Another advantage of dynamic reconfigurable optical interconnect system 300 is provided by slab waveguide 220. Unlike typical optical interconnect systems that employ waveguide crossings and bends in order to create optical paths between devices, dynamic reconfigurable optical interconnect system 300 employs slab waveguide 220 which provides for the non-blocking crossing of collimated light beams 280. This significantly reduces and limits the crosstalk between optical channels that is present in typical optical interconnect systems.

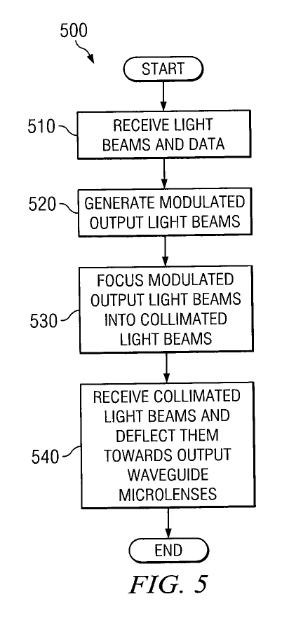

In another embodiment, multiple CW light sources 140 with different wavelengths λ may be utilized to create an optical interconnect with wavelength multiplexing capabilities. For example, FIG. 4 depicts a multiplexing dynamic reconfigurable optical interconnect system 400. Multiplexing dynamic reconfigurable optical interconnect system 400 includes optical interconnect 305 as described above in reference to FIG. 3. In this embodiment, however, each modulator 230 receives a different beam of light with a different wavelength λ from a different CW light source 140 (for example, one of light sources 140a-140d.) Just as in dynamic reconfigurable optical interconnect system 300, a different voltage may be applied to each deflector prism 240 in multiplexing dynamic reconfigurable optical interconnect system 400 in order to dynamically redirect its collimated light beam 280 to a different output waveguide microlens 290. An advantage in this embodiment, however, is that more than one deflector prism 240 may be controlled to direct its collimated light beam 280 to the same output waveguide microlens 290 as another deflector prism 240. As seen in FIG. 4, for example, the three lower collimated light beams 280 are all directed to the second output waveguide microlens 290. This will create a multiplexed collimated light beam 295 having all three wavelengths of light. This significantly increases the potential data transfer rate of the system. This is possible because multiple wavelengths of light were input into optical interconnect 305, and since each collimated light beam 280 has a different wavelength, they will not interfere with each other inside slab waveguide 220 or when combined at a microlens 290. This offers an important advantage over typical systems that provide wavelength multiplexing capabilities. In typical systems, a separate multiplexing device is required to multiplex different wavelengths of light into a single beam before it is connected to a receiving device. In this embodiment, however, there is no need for additional multiplexing devices which provides substantial cost and real estate savings.

This embodiment provides many advantages over typical planar multiplexing devices. One advantage is that this embodiment may be fabricated using ordinary fabrication techniques. Typical planar multiplexing devices require very sophisticated fabrication techniques due the high requirements for dimensional accuracy. In addition, typical planar multiplexing devices are static and do not allow for reconfiguration. This embodiment, however, provides for a highly configurable and flexible switching system. In this embodiment, the multiplexing of signals can be turned on and off by adjusting the voltage to deflector prism 240. In addition, a different number of inputs may be multiplexed together depending on the required operation.

While particular embodiments have been described in detail, numerous changes, substitutions, variations, alterations and modifications may be ascertained by those skilled in the art, and it is intended that the present disclosure encompass all such changes, substitutions, variations, alterations and modifications as falling within the spirit and scope of the appended claims.

With reference now to FIG. 5, an example optical interconnect method 500 is provided. Optical interconnect method 500 begins in step 510 where at least one optical signal is received from a source such as CW light source 140 described above. Data is also received from a data source such as source device 110 and/or main IC 210 described above. In step 520, a modulated output light beam is generated from each of the input light beams and the input data. Step 520 may be implemented by a device such as modulator 230 described above. In step 530, each modulated output light beam is focused into a collimated light beam. Step 530 may be implemented by a device such as input waveguide microlens 250 described above. In step 540, each collimated light beam is received and deflected towards an output waveguide microlens. Step 540 may be implemented by a device such as deflector prism 240 described above.

While a particular optical interconnect method 500 has been described, it should be noted that certain steps may be rearranged, modified, or eliminated where appropriate. Additionally, while certain embodiments have been described in detail, numerous changes, substitutions, variations, alterations and modifications may be ascertained by those skilled in the art, and it is intended that the present disclosure encompass all such changes, substitutions, variations, alterations and modifications as falling within the spirit and scope of the appended claims.

What is claimed is:

1. An optical interconnect system comprising:
an integrated circuit;
at least one optical modulator coupled to the integrated circuit, each optical modulator operable to receive an input light beam from a light source and data from the integrated circuit and to generate a modulated output light beam; and
a slab waveguide coupled to the optical modulator, the slab waveguide further comprising:
at least one input waveguide microlens, each input waveguide microlens operable to focus one of the modulated output light beams from one of the optical modulators into a collimated light beam;
a plurality of output waveguide microlenses; and
at least one deflector prism coupled to the integrated circuit and operable to receive one of the collimated light beams from one of the input waveguide microlenses and deflect the collimated light beam toward one of the output waveguide microlenses according to an input voltage from the integrated circuit.

2. The optical interconnect system of claim 1 further comprising one or more receiving devices, each receiving device coupled to one of the output waveguide microlenses and operable to receive one of the collimated light beams.

3. The optical interconnect system of claim 1 comprising one optical modulator, one input waveguide microlens, and one deflector prism.

4. The optical interconnect system of claim 1 comprising a plurality of optical modulators, a plurality of input waveguide microlenses corresponding to the number of optical modulators, and a plurality of deflector prisms corresponding to the number of input waveguide microlenses.

5. The optical interconnect system of claim 1 wherein the slab waveguide is optically coupled to the optical modulator with an optical fiber, a waveguide, or air.

6. The optical interconnect system of claim 1 wherein the slab waveguide is constructed of an upper cladding layer, a lower cladding layer, and a core layer between the upper cladding layer and lower cladding layer, the core layer comprising an electro-optic material whose refractive index may be adjusted according to a voltage bias.

7. The optical interconnect system of claim 6 wherein each of the deflector prisms are formed with a first electrode between the core layer and upper cladding layer and a second electrode between the core layer and lower cladding layer.

8. The optical interconnect system of claim 6 wherein each of the deflector prisms are formed with a first electrode adjacent to the upper cladding layer and a second electrode adjacent to the lower cladding layer, the first and second electrodes being uncoupled from the core layer.

9. A multiplexing optical interconnect system comprising:
an integrated circuit;
a plurality of light sources, each light source operable to generate a continuous-wave light beam comprising a wavelength of light that is different from the other light sources;
a plurality of optical modulators coupled to the integrated circuit, each optical modulator operable to receive one of the continuous-wave light beams from one of the light sources and data from the integrated circuit and to generate a modulated output light beam comprising the same wavelength of light as the continuous-wave light beam; and
a slab waveguide coupled to the optical modulator, the slab waveguide further comprising:
a plurality of input waveguide microlenses corresponding to the number of optical modulators, each input waveguide microlens operable to focus one of the modulated output light beams from one of the optical modulators into a collimated light beam having the same wavelength of light as the modulated output light beam;
a plurality of output waveguide microlenses; and
a plurality of deflector prisms corresponding to the number of input waveguides, each deflector prism coupled to the integrated circuit and operable to receive one of the collimated light beams from one of the input waveguide microlenses and to deflect the collimated light beam toward one of the output waveguide microlenses according to an input voltage from the integrated circuit.

10. The optical interconnect system of claim 9 wherein the slab waveguide is optically coupled to the optical modulator with an optical fiber, a waveguide, or air.

11. The optical interconnect system of claim 9 wherein the slab waveguide is constructed of an upper cladding layer, a lower cladding layer, and a core layer between the upper cladding layer and lower cladding layer, the core layer comprising an electro-optic material whose refractive index may be adjusted according to a voltage bias.

12. The optical interconnect system of claim 11 wherein each of the deflector prisms are formed with a first electrode between the core layer and upper cladding layer and a second electrode between the core layer and lower cladding layer.

13. The optical interconnect system of claim 11 wherein each of the deflector prisms are formed with a first electrode adjacent to the upper cladding layer and a second electrode adjacent to the lower cladding layer, the first and second electrodes being uncoupled from the core layer.

14. The multiplexing optical interconnect system of claim 9 wherein each of the output waveguide microlenses are operable to receive more than one of the collimated light beams and combine them into a single beam of light comprising all of the wavelengths of light of the more than one received collimated light beams.

15. A method of interconnecting optical signals comprising:
receiving at least one input light beam from at least one light source and data from an integrated circuit;
generating at least one modulated output light beam;
focusing each modulated output light beam into a collimated light beam; and
receiving the collimated light beam and deflecting the collimated light beam toward an output waveguide microlens according to an input voltage from the integrated circuit.

16. A system for interconnecting optical signal comprising:
means for receiving at least one input light beam from at least one light source and data from an integrated circuit;
means for generating at least one modulated output light beam;
means for focusing each modulated output light into a collimated light beam; and
means for receiving the collimated light beam and deflecting the collimated light beam toward a waveguide microlenses according to an input voltage from the integrated circuit.
